(19) United States
(12) Patent Application Publication
(10) Pub. No.: US 2019/0127986 A1
(43) Pub. Date: May 2, 2019

(54) DRY WALL AND METHOD OF MAKING SAME

(71) Applicant: Roger A. May, Kentwood, MI (US)

(72) Inventor: Roger A. May, Kentwood, MI (US)

(21) Appl. No.: 16/122,096

(22) Filed: Sep. 5, 2018

Related U.S. Application Data
(60) Provisional application No. 62/579,509, filed on Oct. 31, 2017.

(51) Int. Cl. E04F 13/04; E04B 2/72; E04C 2/04; E04F 19/02

(52) U.S. Cl. CPC E04F 13/042; E04B 2/721; B32B 13/04; E04F 19/022; E04C 2/043

(57) ABSTRACT

Drywall made with a pre-formed facer layer, pre-formed to have a well-defined depression along the side edge portion of the drywall. When the pre-formed paper is applied to the drywall core, the resulting sheet of drywall has a well-defined depressed edge portion for receiving mud and drywall tape. The facer layer is pre-formed by passing the semi-solid paper slurry beneath an embossing roller which includes a raised circumferential rib on each side of the roller, and preferably at least one raised crossbar. As the semi-solid paper slurry passes beneath embossing roller, a depressed side edge is formed along each side edge portion of the paper, and preferably a wider lateral depression is formed across the width of the paper every 8, 10 or 12 feet along the length of paper as it is pressed by roller.

### CROSS REFERENCE TO RELATED APPLICATIONS

The present application claims priority to provisional patent application Ser. No. 62/555,398 filed Sep. 7, 2017, and to provisional patent application Ser. No. 62/579,509 filed Oct. 31, 2017, each entitled DRY WALL AND METHOD OF MAKING SAME.

### BACKGROUND OF THE INVENTION

The present invention relates to drywall and methods of producing it. Currently, drywall is a panel made of a core of gypsum 10 pressed between a paper facer layer 11 on one side and a backing paper layer 12 on the other (see FIG. 1). During the pressing process, the drywall is pressed to slope downwardly slightly at side edge portions 10a. Thus, when two pieces of drywall are abutted at their edges, there is a slight depression formed into which wet plaster, typically referred to as “mud 3,” is first applied, followed by the application of a piece of drywall tape 4, and then followed by several additional layers of mud, with the joint being sanded between layer applications.

Where the elongated pressed board is cut laterally into individual pieces of dry wall, there is no depression (see FIG. 2). Consequently, taping and mudding the abutting end joints requires spreading the mud 3 laterally from the joint several inches to either side of the joint and tape 4. This helps create the illusion of flatness at the end joints, even though the mud and drywall tape are raised up relative to the remainder of the flat surface of the drywall.

### SUMMARY OF THE INVENTION

The present invention comprises drywall made with a pre-formed facer layer, pre-formed to have a well-defined depression along the side edge portion of the drywall. When the pre-formed paper is applied to the drywall core, the resulting sheet of drywall has a well-defined depressed edge portion for receiving mud and drywall tape.

The facer layer is pre-formed by passing the semi-solid paper slurry beneath an embossing roller which includes a raised circumferential rib on each side of the roller, and preferably at least one raised crossbar. As the semi-solid paper slurry passes beneath embossing roller, a depressed side edge is formed along each side edge portion of the paper, and preferably a wider lateral depression is formed across the width of the paper every 8, 10 or 12 feet along the length of paper as it is pressed by roller.

These and other objects, features and advantages of the invention will be more fully understood and appreciated by reference to the Description of the Preferred Embodiments, and the appended drawings.

### BRIEF DESCRIPTION OF THE DRAWINGS

FIG. 1 is a cross section and perspective view of two pieces of side edge abutting prior art dry wall;

FIG. 2 is a cross section of two pieces of end edge abutting prior art dry wall, showing the application of mud 3 and drywall tape 4 to the joint;

FIG. 3 is a perspective view of a ribbed roller forming the paper slurry which will be dried and cut for application to a dry wall core as the paper facer layer 20;

FIG. 4 is a front elevational view of the roller of FIG. 3;

FIG. 5 is a perspective view of a modified roller which creates a depressed side edge and a thicker fold over portion in the paper;

FIG. 6 is a front elevational view of the roller of FIG. 5;

FIG. 6A is an enlarged view of the portion 6A of FIG. 6;

FIG. 7 is a cross sectional, fragmented view of two pieces of preferred embodiment dry wall abutting end edge to end edge against the opposite end edges of a central piece of dry wall;

FIG. 8 is a cross section of two pieces of end edge abutting preferred embodiment dry wall, with mud and dry wall tape applied to the adjoining top edge depressions;

FIG. 9 is a cross sectional, fragmented view of two pieces of preferred embodiment dry wall abutting side edge to side edge against the opposite side edges of a central piece of dry wall, where the depressed side edge portion 22 of facer paper 20 has been wrapped over the side edge of core 10 to protect the core side edges;

FIG. 10 is a cross section of two pieces of side edge abutting preferred embodiment dry wall, with paper folded over to protect the side edges, and with mud and dry wall tape applied to the adjoining top edge depressions;

FIG. 11 is the same view as FIG. 9, but with facer paper 20 made using the roller of FIGS. 5 and 6, such that the core edge protecting portion 23 of the paper is thicker than the depression portion 22 which receives tape and mud;

FIG. 12 is a cross section of two pieces of side edge abutting preferred embodiment dry wall, with the core edge protecting portion 23 of facer paper 20 folded over to protect the side edges of core 10, and with mud and dry wall tape applied to the adjoining top edge depressions 22; and

FIG. 13 is a perspective view of a roller frame 300 forming the paper slurry which will be dried and cut for application to a dry wall core as the paper facer layer 20.

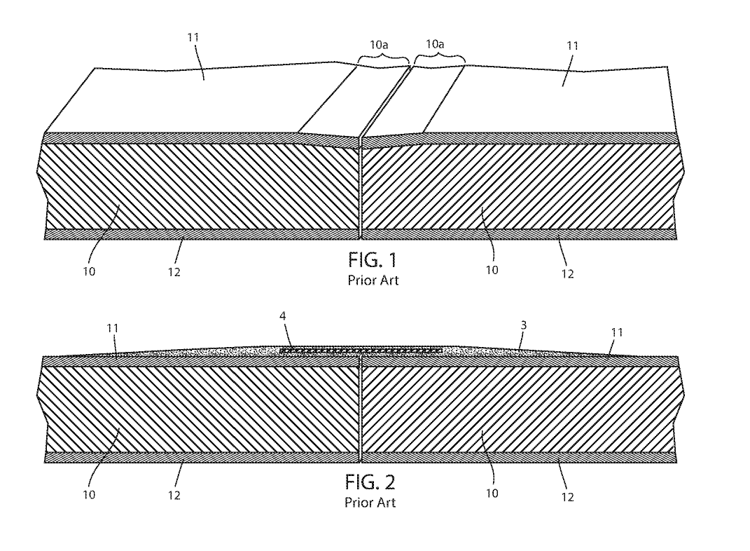

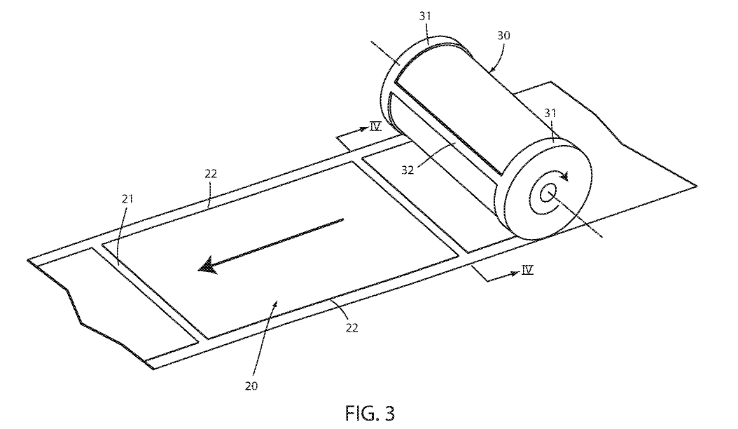

### DESCRIPTION OF THE PREFERRED EMBODIMENTS

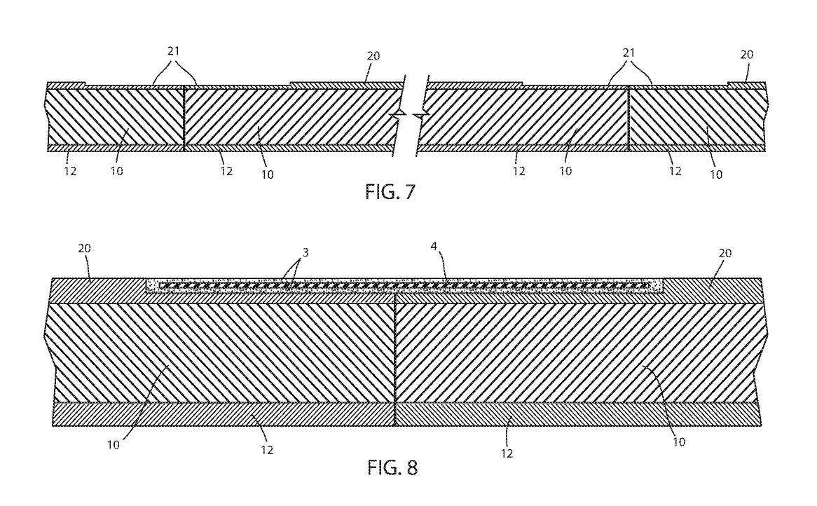

The present invention comprises drywall made with a pre-formed facer layer 20 instead of the conventional prior art facer layer 11 (FIG. 7). Facer layer 20 is pre-formed to have a well-defined depression 21 along the end edge portions of the drywall, and a similar well-defined depression 22 along the side edges. When the pre-formed paper is applied to the core 10, the resulting sheet of drywall has well-defined depressed edge portions 21, 22. As shown in the drawings, the depressions 21 and 22 are well defined in that they are readily visible and include a relatively sharp shoulder 21a or 22a along each inside edge of the depression.

The depth of the depression is set so that it accommodates a layer of mud 3, a layer of drywall tape 4, and a covering layer of mud 3 which is then sanded (FIGS. 8, 10 and 12). Each depression 21 or 22 is wide enough at its respective edge to accommodate ½ the width of applied drywall tape 4, with a little extra space so that the applicator doesn't have to be precise in applying the tape 4 to the drywall joint. Thus, a layer of mud 3 and then a piece of drywall tape 4 in the adjoining depressions 21 or 22 at the end or side edge joints between adjacent sheets of drywall. Because of the consistent, measured depth of each depression 21, the installer should be able to complete installation with a single layer of mud 3, a layer of tape 4, and a single top layer of mud 3. This saves the installer time, in not having to employ multiple layers of mud, each of which must be sanded.

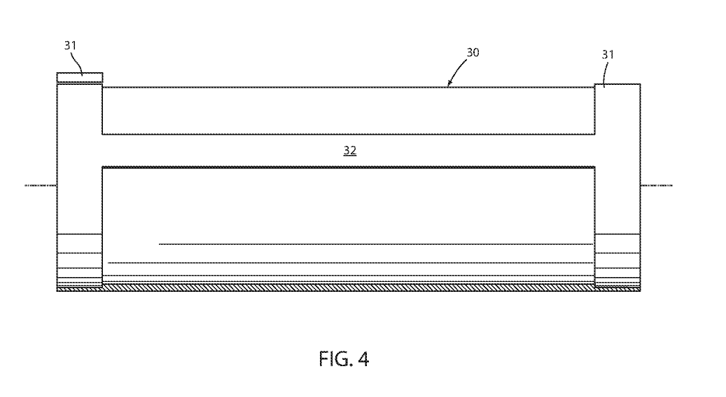

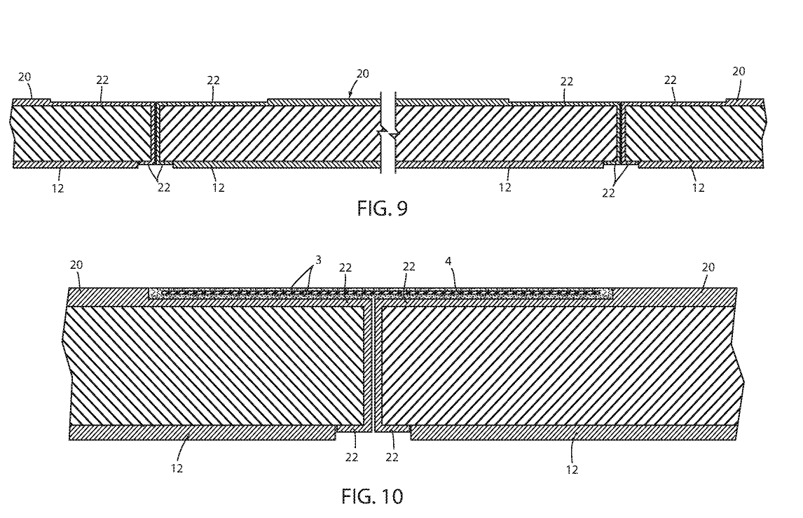

The facing paper 20 is formed by passing the semi-solid paper slurry beneath an embossing press roller 30 (FIGS. 3 and 4). Roller 30 includes a raised circumferential rib 31 on each side of the roller, and preferably at least one raised crossbar 32. As the semi-solid paper slurry passes beneath embossing roller 30, a depressed side edge 22 is formed along each edge portion of the paper, and a depression 21 is formed every 8, 10 or 12 feet along the length of paper 20 as it is pressed by roller 30. The side ribs 31 are wide enough to form a side edge depression 22 which will accommodate ½ the width of a piece of drywall tape 4 with space to spare, and leave an overhanging portion which can be wrapped around the side edge of core 10, and a short distance onto the bottom of the core, as shown in FIGS. 9 and 10. The crossbar 32 is wide enough to form a depression 21 which is wide enough to accommodate the entire width of a piece of drywall tape, since when paper 20 is applied to board core 10, it will be cut laterally in the center of each depression 21. The end edges of the core 10 will not be wrapped and protected, since the drywall, including facer paper 20, is cut through the middle of depressions 21 to create individual drywall pieces. The abutting end edges will have the cross-sectional appearance as shown in FIGS. 7 and 8.

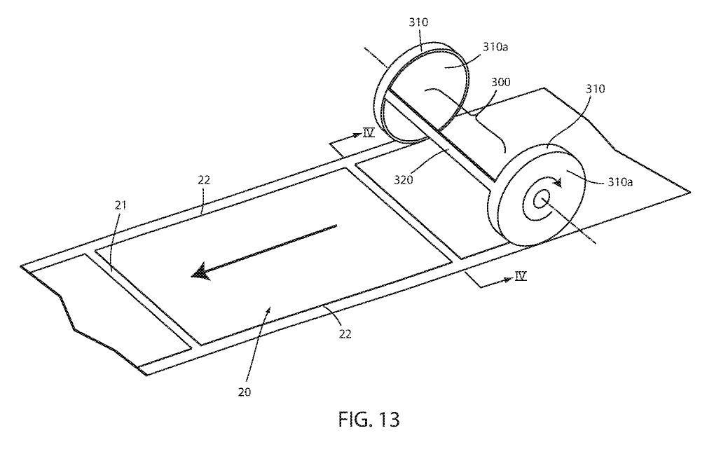

FIG. 13 shows an embossing roller frame 300 which can be used as a less expensive alternative to embossing press roller 30. It includes a circumferential embossing ring 310 on each side, joined by an embossing cross bar 320. These correspond in function to the circumferential rib 31 and raised crossbar 32 of embossing press roller 30. Circumferential ribs 310 are preferably on the outside of a wheel 310a to give them rigidity. It will be understood that further frame members may be used to rigidify embossing cross bar 320. The term embossing roller as used herein refers to either an embossing compression roller 30, or an embossing roller frame 300, or other similar embossing device.

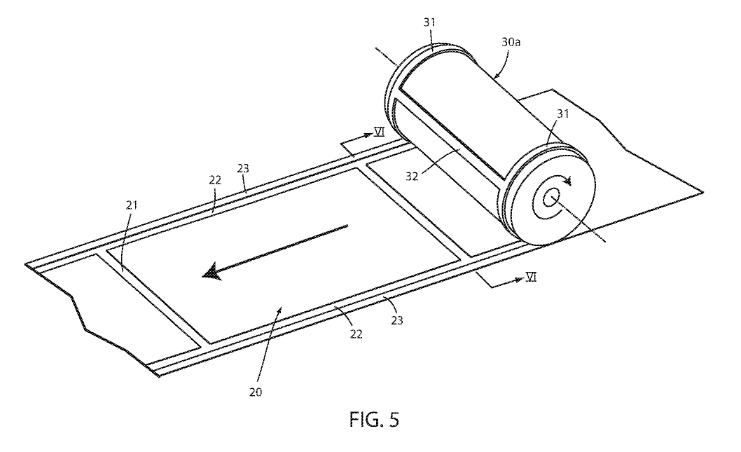

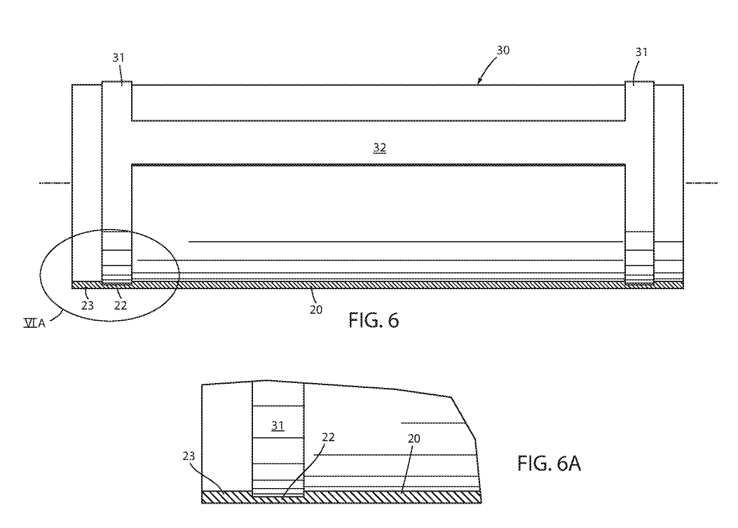

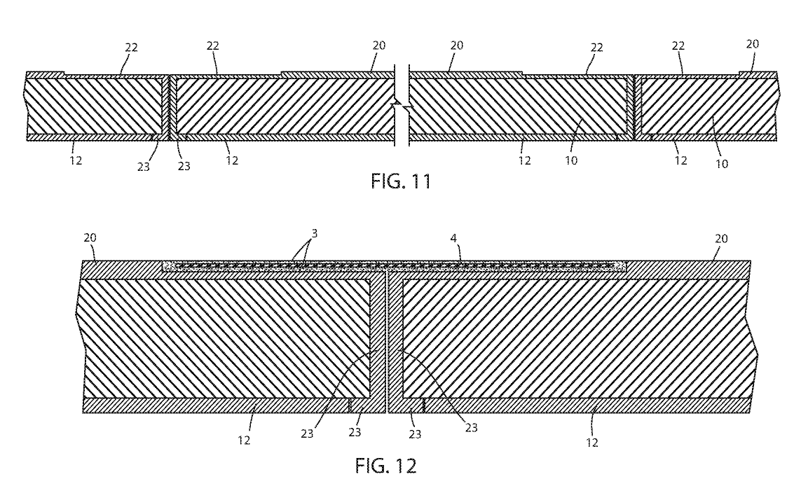

In yet another embodiment, drywall paper 20 is formed by a roller 30a in which circumferential ribs 31 are spaced inwardly from the ends of roller 30 (FIGS. 5 and 6), so that depressions 22 are formed of sufficient width to accommodate ½ the width of the drywall tape 4, but with a thicker core edge protector portion 23 of paper 20 extending beyond depression 22, for wrapping over the side edge of the core and a short distance onto the bottom of the core. (FIGS. 11 and 12.)

In all the embodiments, abutting side edges or end edges of the drywall pieces have a well-defined depression 21 or 22 which accommodates a layer of mud, ½ the width of a piece of drywall tape 4 with enough room to spare that precision application of the tape is not required, and a final layer of drywall tape. The side edges of the core 10 are wrapped and protected by the extending portion of depression 22 in the product as shown in FIGS. 9 and 10, and by a wider edge protecting portion 23 in the product as shown in FIGS. 11 and 12. The end edges of the board do not include a wrapped edge, since the entire drywall piece is cross-cut into appropriate lengths to form the end edges.

### CONCLUSION

Thus, drywall sheets can be produced in the conventional manner, without having to provide a sloping depressed edge portion 10a. Preformed facing paper 20 is attached to the board in a conventional manner and thus provides a precisely dimensioned depression 21 or 22 at each point where adjacent boards are abutted. Because the depression is precisely dimensioned, it is necessary only to apply one layer of mud, a drywall tape and then a top layer of mud which is sanded when dried.

1. Drywall having a core with a pre-formed facer layer, with a well-defined depression along the side edge portion of said drywall for receiving mud and drywall tape.

2. The drywall of claim 1 wherein said pre-formed facer layer also includes a well-defined depression along each end edge of said drywall.

3. The drywall of claim 2 in which each said well-defined depression is wide enough to accommodate ½ the width of applied drywall tape, with a little extra space so that the applicator doesn't have to be precise in applying the tape to the drywall joint at which adjacent sheets of drywall abut and being sufficiently deep to accommodate at least one layer of mud covering said drywall tape.

4. The drywall of claim 3 in which each said well-defined depression in said pre-formed facing layer is wide enough to not only accommodate ½ the width of a piece of drywall tape with space to spare, but also to leave an overhanging portion which can be wrapped around the side edge of said core, and a short distance onto the bottom of the core.

5. The drywall of claim 3 in which at least each said well-defined depression along a side edge of said pre-formed facing layer is wide enough to not only accommodate ½ the width of a piece of drywall tape with space to spare, but also to leave an overhanging thicker core edge protector portion for wrapping over the side edge of the core and a short distance onto the bottom of the core.

6. Preformed drywall facing paper for application to a drywall core in which said preformed paper comprises: a well-defined depression along the side edge portion of said paper for receiving mud and drywall tape when applied to a drywall core.

7. The preformed drywall facing paper of claim 6 in which said pre-formed facer layer also includes a well-defined depression extending laterally across the width of said pre-formed face layer to be located adjacent each end edge of a drywall core to which said paper layer will be attached.

8. The preformed drywall facing paper of claim 7 in which each said well-defined depression is wide enough to accommodate ½ the width of applied drywall tape, with a little extra space so that the applicator doesn't have to be precise in applying the tape to the drywall joint at which adjacent sheets of drywall abut, and being sufficiently deep to accommodate at least one layer of mud covering said drywall tape.

9. The preformed drywall facing paper of claim 8 in which each said well-defined depression in said pre-formed facing layer is wide enough to not only accommodate ½ the width of a piece of drywall tape with space to spare, but also to leave an overhanging portion which can be wrapped around the side edge of said core, and a short distance onto the bottom of the core.

10. The preformed drywall facing paper of claim 8 in which at least each said well-defined depression along a side edge of said pre-formed facing layer is wide enough to not only accommodate ½ the width of a piece of drywall tape 4 with space to spare, but also is spaced inwardly from the outside edge of said facing paper to leave an overhanging thicker core edge protector portion for wrapping over the side edge of the core and a short distance onto the bottom of the core.

11. A method for making drywall by preforming a facing paper layer for application to a drywall core, comprising: passing a semi-solid paper slurry beneath an embossing roller which comprises a circumferential embossing rib on each side of said semi-solid paper slurry, and forming with said embossing roller a well-defined side edge depression along each edge portion of the paper, as said paper slurry passes beneath said embossing roller; each said circumferential embossing rib being wide enough to form a well-defined side edge depression which will accommodate ½ the width of a piece of drywall tape with space to spare so that the applicator doesn't have to be precise in applying the tape to a joint between abutting drywall sheets when said facing paper layer is applied to a core, and deep enough to accommodate at least one layer of drywall tape and at least one covering layer of mud; applying said facing paper layer to drywall core.

12. The method of claim 11 in which: said embossing roller includes an embossing cross bar located to form a lateral depression extending from side to side of said semi-solid paper slurry, every 8, 10 or 12 feet along the length of paper slurry as it passes beneath said embossing roller; said crossbar being wide enough to form a well-defined lateral depression which is wide enough to accommodate the entire width of a piece of drywall tape, and deep enough to accommodate at least one layer of covering mud; cutting said combined core and applied paper covering laterally across said combined core and applied paper along the center of said lateral depression to form separate sheets of drywall.

13. The method of claim 12 in which each said circumferential embossing rib is sufficiently wide to form said well-defined side edge depression in said pre-formed facing layer which is wide enough to not only accommodate ½ the width of a piece of drywall tape with space to spare, but also to leave an overhanging portion which can be wrapped around the side edge of said core, and a short distance onto the bottom of the core.

14. The method of claim 13 in which each said circumferential embossing rib is spaced inwardly a sufficient distance from the edge of said passing semi solid paper slurry to leave a thicker core edge protector portion of said preformed paper which extends beyond said side edge depression formed by said circumferential embossing rib, for wrapping over the side edge of the core and a short distance onto the bottom of the core.

15. The method of claim 14 in which said embossing roller used is an embossing compression roller.

16. The method of claim 14 in which said embossing roller used is an embossing roller frame.

17. The method of claim 11 in which each said circumferential embossing rib is sufficiently wide to form said well-defined side edge depression in said pre-formed facing layer which is wide enough to not only accommodate ½ the width of a piece of drywall tape with space to spare, but also to leave an overhanging portion which can be wrapped around the side edge of said core, and a short distance onto the bottom of the core.

18. The method of claim 17 in which each said circumferential embossing rib is spaced inwardly a sufficient distance from the edge of said passing semi solid paper slurry to leave a thicker core edge protector portion of said preformed paper which extends beyond said side edge depression formed by said circumferential embossing rib, for wrapping over the side edge of the core and a short distance onto the bottom of the core.

19. The method of claim 18 in which said embossing roller used is an embossing compression roller.

20. The method of claim 18 in which said embossing roller used is an embossing roller frame.
